(19) United States
(12) Patent Application Publication
(10) Pub. No.: US 2015/0248465 A1
(43) Pub. Date: Sep. 3, 2015

(54) METHOD AND APPARATUS FOR PROCESSING HISTORY OPERATION RECORDS OF ELECTRONIC TERMINAL, AND STORAGE MEDIUM

(71) Applicant: TENCENT TECHNOLOGY (SHENZHEN) COMPANY LIMITED, Shenzhen (CN)

(72) Inventors: Zhou YAN, Shenzhen (CN); Guang YANG, Shenzhen (CN); Anqi LI, Shenzhen (CN); Qinghua ZHONG, Shenzhen (CN)

(21) Appl. No.: 14/714,140

(22) Filed: May 15, 2015

Related U.S. Application Data
(63) Continuation of application No. PCT/CN2013/083660, filed on Sep. 17, 2013.

(30) Foreign Application Priority Data
Nov. 19, 2012 (CN) 201210468040.X

(51) Int. Cl. G06F 17/30; G06F 11/14

(52) U.S. Cl. CPC G06F 17/30554; G06F 17/30867; G06F 17/30598; G06F 11/1448; G06F 17/30312; G06F 2201/80

(57) ABSTRACT

The present disclosure relates to a method for processing history operation records of an electronic terminal, including: recording, after an application program completes a predetermined operation, an operation record about the predetermined operation, the operation record at least including a target object, an operation time, and an action; performing cluster analysis on the operation records to separately aggregate operation records of each target object; receiving a request for displaying operation records, acquiring a time period which is included in the request and during which operation records to be displayed are located; and displaying, in a first display area according to the request, aggregated operation records of at least one target object during the time period. The foregoing method helps a user quickly find a needed file or folder in history operation records. In addition, the present disclosure further provides an apparatus for processing history operation records of an electronic terminal.

### RELATED APPLICATION

This application is a continuation of International Application No. PCT/CN2013/083660, filed on Sep. 17, 2013, which claims priority to Chinese Patent Application No. 201210468040.X, filed by TENCENT TECH (SHENZHEN) CO LTD on Nov. 9, 2012, and entitled “METHOD AND APPARATUS FOR PROCESSING HISTORY OPERATION RECORDS OF ELECTRONIC TERMINAL”, the contents of both of which are incorporated herein by reference in their entireties.

### FIELD OF THE TECHNOLOGY

The present disclosure relates to technologies for processing history operation records of electronic terminals, and in particular, to a method and an apparatus for processing history operation records of an electronic terminal, and a storage medium.

### BACKGROUND OF THE DISCLOSURE

An existing technical solution may record a use history of a user by category, for example, the Windows XP operating system provides a function of “recent documents” to display files recently opened by each program. However, these functions are relatively simple and have the following disadvantages:

(1) History records are scattered, ingress is relatively deep, and documents cannot be checked uniformly.

(2) There is no record of a file newly added to or deleted from a system, and a user cannot quickly search for a file downloaded just now and cannot remedy situations such as missing of a file caused by a misoperation.

(3) The document history and versions are not saved completely or are not saved at all in the existing solution.

(4) Statistics about history records in the existing solution cannot be collected, which cannot help a user sort and review previous work thereof.

(5) Records in the existing solution are merely the history of files opened, which cannot produce greater value in social intercourse or application recommendation for a user.

### SUMMARY

In view of this, it is necessary to provide a method and an apparatus for processing history operation records of an electronic terminal. The method and the apparatus can help a user quickly and clearly know various operations carried out in a specific time period and successfully find a related file and folder, information that has been sent, and the like.

A method for processing history operation records of an electronic terminal includes: recording, after an application program completes a predetermined operation, an operation record about the predetermined operation, the operation record at least including a target object, an operation time, and an action; performing cluster analysis on the operation records to separately aggregate operation records of each target object; receiving a request for displaying operation records, and acquiring a time period which is included in the request and during which operation records to be displayed are located; and displaying, in a first display area according to the request, aggregated operation records of at least one target object during the time period.

An apparatus for processing history operation records of an electronic terminal includes: a recording module, configured to record, after an application program completes a predetermined operation, an operation record about the predetermined operation, the operation record at least including a target object, an operation time, and an action; an analysis module, configured to perform cluster analysis on the operation records to separately aggregate operation records of each target object; a time selection module, configured to receive a request for displaying operation records, and acquire a time period which is included in the request and during which operation records to be displayed are located; and an operation record display module, configured to display, in a first display area according to the request, aggregated operation records of at least one target object during the time period.

In foregoing method and apparatus for processing history operation records, history operation records of an electronic apparatus are recorded and are displayed in an interface in a clustered manner, so as to help a user quickly and clearly know various operations carried out in a specific time period and successfully find a related file and folder.

### BRIEF DESCRIPTION OF THE DRAWINGS

To make the foregoing and other objectives, features, and advantages of the present disclosure easier to understand, the following makes a detailed description with reference to preferred embodiments and the accompanying drawings, where

FIG. 1 is a flowchart of a method for processing history operation records of an electronic terminal according to a first embodiment of the present invention;

FIG. 2 is a schematic diagram of displayed operation records in a method for processing history operation records of an electronic terminal according to a first embodiment of the present invention;

FIG. 3 is a schematic diagram of displayed operation records in a method for processing history operation records of an electronic terminal according to a second embodiment of the present invention;

FIG. 4 is a schematic diagram of displayed operation records in a method for processing history operation records of an electronic terminal according to a third embodiment of the present invention; and

FIG. 5 is a structural block diagram of an apparatus for processing history operation records of an electronic terminal according to a fourth embodiment of the present invention.

### DESCRIPTION OF EMBODIMENTS

To further explain the technical means used in the present disclosure for achieving the intended objectives and the technical effects of the present disclosure, specific implementation manners, structures, features, and technical effects of the present disclosure are described in detail below with reference to the accompanying drawings and preferred embodiments.

Embodiments of the present invention provide a method and an apparatus for processing history operation records of an electronic terminal. The electronic terminal refers to, for example, an electronic apparatus that runs an operating system and can receive a user input and complete a corresponding data processing operation. Specific examples of the electronic terminal may include a computer, a smart phone, a tablet computer, and the like. The operation refers to steps executed in the electronic terminal for implementing a function, for example, creating, editing, saving, deleting, downloading, or uploading a file, publishing information on the Internet, and sending an email. It can be understood that all operations are executed based on application programs. However, it should be noted that the application program herein is not limited to an application program that a user installs. Each application provided by the operating system can be regarded as an application program.

### Embodiment 1

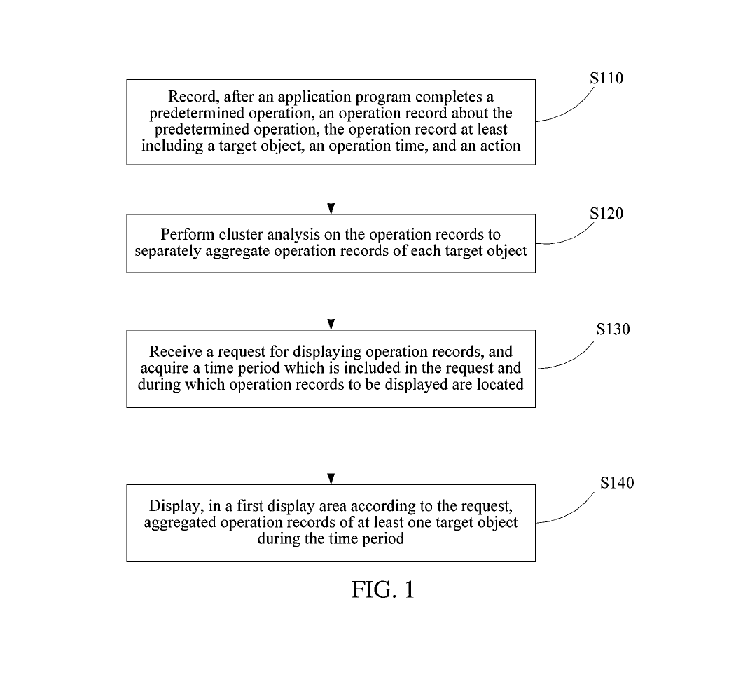

Referring to FIG. 1, FIG. 1 shows a method for processing history operation records of an electronic terminal according to this embodiment. The method includes the following steps S110 to S140:

Step S110: Record, after an application program completes a predetermined operation, an operation record about the predetermined operation, the operation record at least including a target object, an operation time, and an action.

The application program includes an application program that a user installs and an application program embedded in an operating system. These application programs may be used for webpage browsing, word processing, image processing, audio and video processing, or system setting.

The predetermined operation refers to an operation that needs to be recorded, and may include, for example, creating, updating, and deletion of a file/folder, and alteration of system information. The creating of a file refers to that, for example, a user creates, by using an application program, a file that does not exist before, and stores the file in a storage apparatus; the updating refers to that a user edits content of a file/folder by using an application program and saves the edited content; and the deletion refers to deleting an existing file/folder. It can be understood that, to cater for system running, generally, the operating system of the electronic apparatus also performs the foregoing operations continually. However, ordinary users do not need to pay attention to most of system operations. Therefore, the foregoing operation that needs to be recorded refers to, for example, an operation that can generate user data or a data operation related to personal settings of the user. Generally, the operation for generating user data is intended for an object that does not exist in a system directory, or the operation for generating user data does not have a target object. Specific examples of the object may include: a document created and saved by using word processing software (for example, Word), a design drawing generated by using design software, a photo imported from an external data source, an instant message input in instant communication software and sent, and the like. A data operation related to personal settings of a user is generally intended for a specific parameter of a system or an application program (for example, a registry of the Windows system).

The target object refers to an object processed by the application program, and specifically may be, for example, files and folders in various formats or setting parameters of a system or an application. By using the Windows system as an example, if a user creates a text file D:\test.txt in a hard disk partition D by using a built-in file browser (explorer.exe) of the system, D:\test.txt is the target object; if a folder D:\test is created, the folder D:\test is the target object; and if a file D:\1.txt is deleted, the file D:\1.txt is the target object. If a user modifies a value of an item in the registry by using a built-in registry editor of the system, the registry item is the target object. If a user opens a file D:\Documents\test.doc by using file processing software, the file D:\Documents\test.doc is the target object described above.

It can be understood that sequential data of operation records shown in Table 1 can be obtained after step S110:

TABLE 1
Sequential data of operation records of an
electronic terminal in a given time period

| Operation time | Action | Target object | . . . |
|---|---|---|---|
| 2012/11/8/15:32:00 | Create | D:\test | . . . |
| 2012/11/8/15:32:15 | Create | D:\test\test.txt | . . . |
| 2012/11/8/15:32:30 | Delete | D:\1.txt | . . . |
| 2012/11/8/15:32:38 | Create | D:\Documents\test.doc | |
| 2012/11/8/15:38:45 | Update | D:\Documents\test.doc | . . . |
| 2012/11/8/15:42:00 | Update | D:\test\test.txt | . . . |
| 2012/11/8/15:46:15 | Update | D:\Documents\test.doc | . . . |

Step S120: Perform cluster analysis on the operation records to separately aggregate operation records of each target object.

The operation records shown in Table 1 relate to four target objects in total: “D:\test”, “D:\test\test.txt”, “D:\1.txt”, and “D:\Documents\test.doc”. A cluster analysis result similar to that shown in Table 2 can be obtained after cluster analysis is performed on different target objects:

TABLE 2
Cluster analysis result of sequential
data of operation records in Table 1

| Target object | Operation time | Action | . . . |
|---|---|---|---|
| D:\test | 2012/11/8/15:32:00 | Create | . . . |
| D:\test\test.txt | 2012/11/8/15:32:15 | Create | . . . |
| | 2012/11/8/15:42:00 | Update | . . . |
| D:\1.txt | 2012/11/8/15:32:30 | Delete | . . . |
| D:\Documents\test.doc | 2012/11/8/15:32:38 | Create | |
| | 2012/11/8/15:38:45 | Update | . . . |
| | 2012/11/8/15:46:15 | Update | . . . |

Step S130: Receive a request for displaying operation records, and acquire a time period which is included in the request and during which operation records to be displayed are located.

For example, after a user runs an application program, when a default interface of the application program is a page displaying operation records, or the user selects a specific entry (for example, a button, a link, or a menu) of the application program, or the user presses a specific hardware key, or a specific gesture or voice command is detected, it can be regarded that a request for displaying operation records is received.

The time period may be a time period set by a user or a time period selected by default, such as latest two hours, four hours, or one day.

Step S140: Display, in a first display area according to the request, aggregated operation records of at least one target object during the time period.

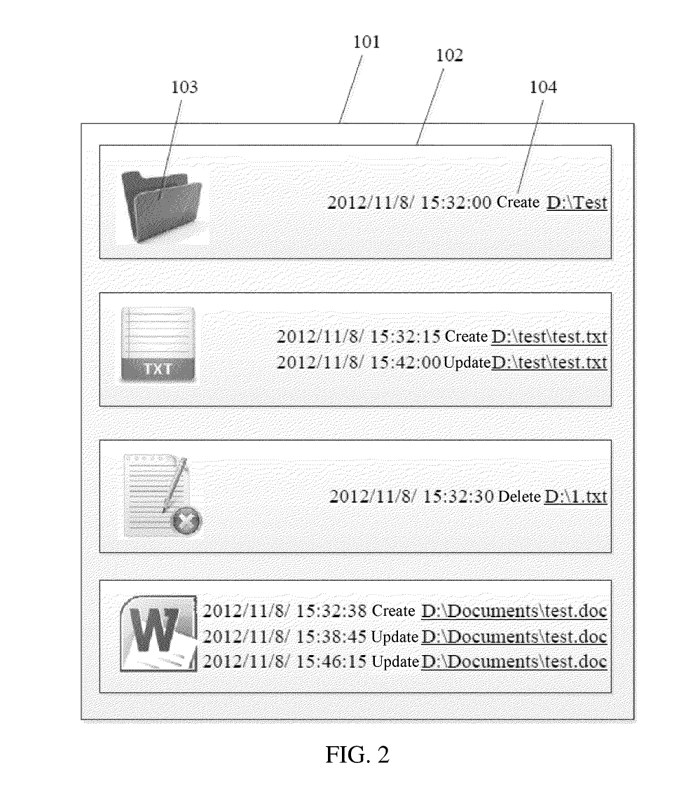

As shown in FIG. 2, a first display area 101 is used to display aggregated operation records. Operation records of each target object are displayed in an independent subarea 102. In the example shown in FIG. 2, an icon 103 of the target object is displayed on a first side (the left side) of the subarea 102, and a specific action prompt 104 is displayed on a second side (the right side). After the predetermined user operation such as clicking is detected in the area of the action prompt 104 and a surrounding area thereof (not beyond the range of the subarea 102), a predetermined function such as opening the target object can be triggered.

In the display manner shown in FIG. 2, multiple operation records of each file can be displayed. It can be understood that each operation record actually corresponds to different versions of a file. In the method of this embodiment, apart from recording operation records, an updated file may be backed up. During backup, a full backup manner or an incremental backup manner may be used, where in the incremental backup manner, on the basis of the first full backup, all subsequent backups only store changed data and records.

Because backups corresponding to the operation records are stored, the predetermined function may also be opening a corresponding backup. In this way, the user may further trace different versions of a file easily by using the interface shown in FIG. 2, for example, the action prompt 104 may serve as a link of a corresponding file backup. In other words, the operation records in the first display area 101 are associated with corresponding file backups.

Further, a use habit and preference of a user may be obtained by analyzing recorded operation record data of the user, so that information such as functions, applications, and consults are accurately pushed to the user. For example, if the user uses a graphic processing application most frequently, graphic processing applications may be accordingly pushed to the user, for the user to choose from. The foregoing push interface may be displayed, for example, at the top or bottom of the first area 101.

In the foregoing method for processing history operation records, history operation records of an electronic apparatus are recorded and displayed in an interface by means of clustering, so that a user can quickly and clearly know various operations carried out in a specific time period and successfully find a related file and folder.

### Embodiment 2

This embodiment provides a method for processing history operation records of an electronic terminal. This method is similar to the method in Embodiment 1, and the difference lies in that: the operation record further includes an identifier of the related application program, so that sequential data of operation records similar to those shown in Table 3 can be formed.

TABLE 3
Sequential data of operation records of an
electronic terminal in a given time period

| | | | Application | |
|---|---|---|---|---|
| Operation time | Action | Target object | program | . . . |
| 2012/11/8/15:32:00 | Create | D:\test | Explorer.exe | . . . |
| 2012/11/8/15:32:15 | Create | D:\test\test.txt | Notepad.exe | . . . |
| 2012/11/8/15:32:30 | Delete | D:\1.txt | Explorer.exe | . . . |
| 2012/11/8/15:32:38 | Create | D:\Documents\test.doc | Word.exe | |
| 2012/11/8/15:38:45 | Update | D:\Documents\test.doc | Word.exe | . . . |
| 2012/11/8/15:42:00 | Update | D:\test\test.txt | Notepad.exe | . . . |
| 2012/11/8/15:46:15 | Update | D:\Documents\test.doc | Word.exe | . . . |

Accordingly, similar to step 120 in Embodiment 1, cluster analysis may be performed according to application programs. The operation records of a same application program are aggregated together according to an identifier of the application program, so that a cluster analysis result similar to that shown in Table 4 can be obtained.

TABLE 4
Cluster analysis result of sequential
data of operation records in Table 1

| Application | Operation time | Action | Target object | . . . |
|---|---|---|---|---|
| Explorer.exe | 2012/11/8/15:32:00 | Create | D:\test | . . . |
| | 2012/11/8/15:32:30 | Delete | D:\1.txt | . . . |
| Notepad.exe | 2012/11/8/15:32:15 | Create | D:\test\test.txt | . . . |
| | 2012/11/8/15:42:00 | Update | D:\test\test.txt | . . . |
| Word.exe | 2012/11/8/15:32:38 | Create | D:\Documents\test.doc | |
| | 2012/11/8/15:38:45 | Update | D:\Documents\test.doc | . . . |
| | 2012/11/8/15:46:15 | Update | D:\Documents\test.doc | . . . |

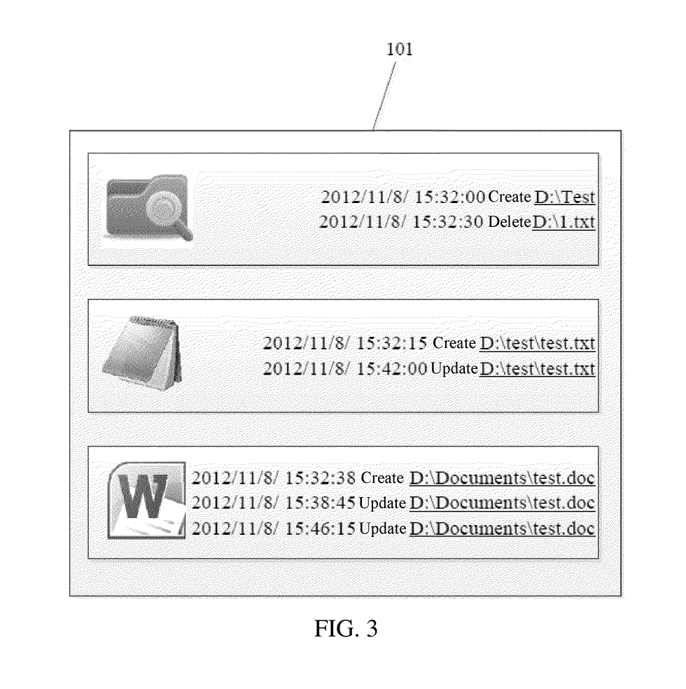

According to the foregoing cluster analysis result, the display result shown in FIG. 3 can be obtained by using a display manner similar to that in step S140 of Embodiment 1.

In the foregoing method for processing history operation records, history operation records of an electronic apparatus are recorded and displayed in an interface by means of clustering according to identifiers of application programs, so that a user can quickly and clearly know various operations carried out by various application programs in a specific time period and successfully find a related file and folder.

It can be understood that the manner in Embodiment 1 mainly describes history operation records from the perspective of alterations of files/folders, and in such manner, a user can find a document in a given time period more easily. However, the manner in Embodiment 2 mainly describes history operation records from the perspective of application programs, and in such manner, a user can better know operation records of different application programs.

Further, the manners in Embodiment 1 and Embodiment 2 can be combined to display not only the result of the cluster analysis on the target objects but also the result of cluster analysis on the application programs.

### Embodiment 3

This embodiment provides a method for processing history operation records of an electronic terminal. This method is similar to the method in Embodiment 1, and the difference lies in further that, this method further includes: displaying a time index in a second display area.

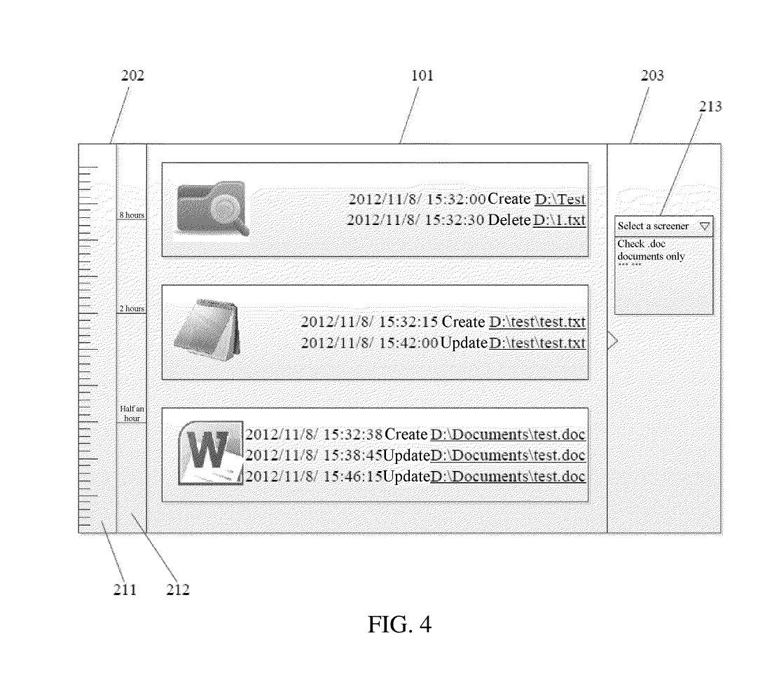

Referring to FIG. 4, a time index is displayed in a second display area 202. In this embodiment, a time index 210 includes a first time scale 211 and a second time scale 212. The first time scale 211 may be used to set a date, and the second time scale 212 may be used to set a specific time (or time period). A user may select a time point by clicking and/or dragging the first time scale 211 and the second time scale 212. Accordingly, after the user completes the operation, the background can acquire the time period during which operation records to be displayed are located.

Accordingly, if it is detected that a time point selected from the time index 210 changes, the target object displayed in the first display area 101 is updated correspondingly. A specific process thereof is as follows: filtering the operation records by selecting a time point of operation time. For example, in the embodiment shown in FIG. 4, operation records in the latest two hours are selected. Then, operation records two hours ago are filtered out.

It can be understood that the time index 210 is not limit to the manner shown in FIG. 4, for example, time scales may also be displayed in a transverse manner. Further, the foregoing time scale manner may not be used, for example, a control for selecting a time period, such as a dropdown list or a button, may be directly provided, so that the user directly selects a time period during which operation records to be displayed are located.

Further, this embodiment may further include the following steps: displaying a filter setting interface in a third area; and filtering target objects displayed in the first display area according to the selected filter.

As shown in FIG. 4, a third area 203 is used to display a filter 213. The filter 213 can be used to set one or more retrieving rules. One or more target objects displayed in the first area 101 may be filtered by executing the retrieving rules, and only a result desired to be displayed is reserved. The foregoing retrieving rules are, for example, only checking newly added files or only checking files of a given format (such as .doc documents). However, a specific condition for retrieval relies on fields saved in the operation records, and content of all fields in the operation records can be used to retrieve and filter the operation records. Retrieving conditions may be further combined with each other. For example, only .doc files updated in the latest two hours are checked.

It can be understood that the time index is also a filter in fact. Therefore, a function of the time index may be combined in the filter 213. The third area 203 in which the filter 213 is located may be automatically hidden to provide more display space, and can be displayed again after a specific operation is detected.

It can be understood that although the foregoing step is used to filter displayed target objects by using time and a filter, when the user imports many files at one time in an automated manner, a great number of operation records may still be generated in a relatively short time period, and if each document is displayed separately in the manner described in Embodiment 1, undoubtedly, it is hard for a user to find an object the user really focuses on. Multiple files satisfying given features may be collectively displayed, for example, image files continuously imported in a time period are displayed as one target object, and some main digest information is displayed by using description text such as “X images are imported”.

In this embodiment, a time index and a filter are displayed, so that a user can conveniently find an operation record of a needed file or a specific program, and conveniently restore a working state.

### Embodiment 4

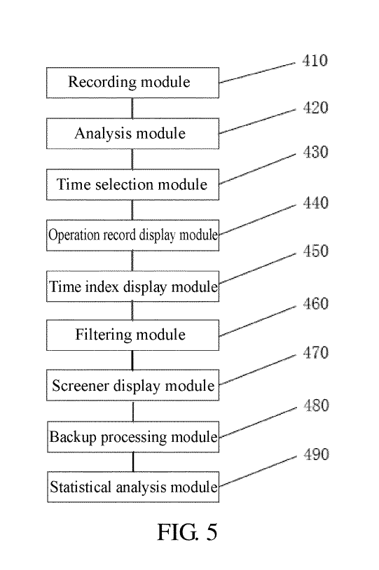

This embodiment provides an apparatus for processing history operation records of an electronic terminal. As shown in FIG. 5, the apparatus includes a recording module 410, an analysis module 420, a time selection module 430, and an operation record display module 440.

The recording module 410 is configured to record, after an application program completes a predetermined operation, an operation record about the predetermined operation, the operation record at least including a target object, an operation time, and an action; the analysis module 420 is configured to perform cluster analysis on the operation records to separately aggregate operation records of each target object; the time selection module 430 is configured to receive a request for displaying operation records, and acquire a time period which is included in the request and during which operation records to be displayed are located; and the operation record display module 440 is configured to display, in a first display area according to the request, aggregated operation records of at least one target object during the time period.

The operation record further includes an identifier of the application program; and accordingly, the analysis module 420 is further configured to perform cluster analysis on the operation records to separately aggregate operation records of each application program. The operation record display module 440 is further configured to display, in the first display area, aggregated operation records of at least one application program.

Further, the foregoing processing apparatus may further include: a time index display module 450 and a filtering module 460. The time index display module 450 is configured to display a time index in a second display area; and the acquiring, by the time selection module 430, a time period during which operation records to be displayed are located includes acquiring a selected time point from the time index. The filtering module 460 is configured to correspondingly update the target object displayed in the first display area after it is detected that the selected time point in the time index changes. Further, the processing apparatus may further include: a filter display module 470, configured to display a filter setting interface in a third display area. The filtering module 460 is further configured to filter target objects displayed in the first display area by using the filter.

Further, the foregoing processing apparatus may further include: a backup processing module 480, configured to back up a corresponding file after the application program completes the predetermined operation, and associate the operation records displayed in the first display area with backups of the corresponding file.

Further, the foregoing processing apparatus may further include: a statistical analysis module 490, configured to perform statistical analysis on the operation records, and recommend a corresponding application to a user according to the statistical analysis.

For other details about the foregoing processing apparatus, reference may be further made to FIG. 1 to FIG. 4 and related descriptions.

In the foregoing method for processing history operation records, history operation records of an electronic apparatus are recorded and displayed in an interface by means of clustering, so that a user can quickly and clearly know various operations carried out in a specific time period and successfully find a related file and folder.

Moreover, embodiments of the present invention further provide a computer readable storage medium that stores a computer executable instruction therein, where the computer readable storage medium may be a non-volatile memory such as an optical disc, a hard disk or a flash memory. The computer executable instruction is used for instructing a computer or a similar computing apparatus to implement various operations in the foregoing method for processing history operation records of an electronic apparatus.

The above descriptions are merely preferred embodiments of the present invention, and are not intended to limit the present disclosure in any form. Although the present disclosure has been disclosed above through the foregoing preferred embodiments, the embodiments are not intended to limit the present disclosure. A person skilled in the art can make replacements or modifications to the above-disclosed technical content without departing from the scope of the technical solutions of the present disclosure to obtain equivalent embodiments. Any alteration, equivalent change or modification made to the above embodiments according to the technical essence of the present disclosure without departing from the content of the technical solutions of the present disclosure shall fall within the scope of the technical solutions of the present disclosure.

What is claimed is:

1. A method for processing history operation records of an electronic terminal, comprising:
recording, after an application program completes a predetermined operation, an operation record about the predetermined operation, the operation record at least comprising a target object, an operation time, and an action;
performing cluster analysis on the operation records to separately aggregate operation records of each target object;
receiving a request for displaying operation records, and acquiring a time period which is comprised in the request and during which operation records to be displayed are located; and
displaying, in a first display area according to the request, aggregated operation records of at least one target object during the time period.

2. The method for processing history operation records of an electronic terminal according to claim 1, wherein the operation record further comprises an identifier of the application program that executes the action on the target object; and
the method further comprises: performing cluster analysis on the operation records to separately aggregate operation records of each application program; and displaying, in the first display area according to the identifier, aggregated operation records of at least one application program during the time period.

3. The method for processing history operation records of an electronic terminal according to claim 1, wherein the method further comprises: displaying a time index in a second display area; and the acquiring the time period during which operation records to be displayed are located comprises acquiring a selected time point from the time index.

4. The method for processing history operation records of an electronic terminal according to claim 3, wherein the method further comprises: correspondingly updating the target object displayed in the first display area after it is detected that the selected time point changes.

5. The method for processing history operation records of an electronic terminal according to claim 1, wherein the method further comprises: displaying a filter setting interface in a third display area; and
filtering target objects displayed in the first display area by using the filter.

6. The method for processing history operation records of an electronic terminal according to claim 1, wherein the method further comprises: generating a backup of a corresponding file after the application program completes the predetermined operation; and associating the operation records displayed in the first display area with the backup of the corresponding file.

7. The method for processing history operation records of an electronic terminal according to claim 1, wherein the method further comprises: performing a statistical analysis on the operation records and recommending a corresponding application to a user according to the statistical analysis.

8. An apparatus for processing history operation records of an electronic terminal, comprising:
a recording module, configured to record, after an application program completes a predetermined operation, an operation record about the predetermined operation, the operation record at least comprising a target object, an operation time, and an action;
an analysis module, configured to perform cluster analysis on the operation records to separately aggregate operation records of each target object;
a time selection module, configured to receive a request for displaying operation records, and acquire a time period which is comprised in the request and during which operation records to be displayed are located; and
an operation record display module, configured to display, in a first display area according to the request, aggregated operation records of at least one target object during the time period.

9. The apparatus for processing history operation records of an electronic terminal according to claim 8, wherein the operation record further comprises an identifier of the application program for executing the action on the target object; and
the analysis module is further configured to perform cluster analysis on the operation records to separately aggregate operation records of each target object; and
the operation record display module is further configured to display, in the first display area according to the identifier, aggregated operation records of at least one application program during the time period.

10. The apparatus for processing history operation records of an electronic terminal according to claim 8, wherein the apparatus further comprises a time index display module, configured to display a time index in a second display area; and the acquiring, by the time selection module, a time period during which operation records to be displayed are located comprises acquiring a selected time point from the time index.

11. The apparatus for processing history operation records of an electronic terminal according to claim 10, wherein the apparatus further comprises: a filtering module, configured to correspondingly update the target object displayed in the first display area after it is detected that the selected time point in the time index changes.

12. The apparatus for processing history operation records of an electronic terminal according to claim 8, wherein the apparatus further comprises: a filter display module, configured to display a filter setting interface in a third display area; and
the filtering module is further configured to filter target objects displayed in the first display area by using the filter.

13. The apparatus for processing history operation records of an electronic terminal according to claim 8, wherein the apparatus further comprises: a backup processing module, configured to generate a backup of a corresponding file after the application program completes the predetermined operation and associate the operation records displayed in the first display area with the backups of the corresponding file.

14. The apparatus for processing history operation records of an electronic terminal according to claim 8, wherein the apparatus further comprises: a statistical analysis module, configured to perform statistical analysis on the operation records and recommend a corresponding application to a user according to the statistical analysis.

15. A storage medium comprising a computer executable instruction, the computer executable instruction being used for executing a search method when executed by a computer processor, the method comprising:
recording, after an application program completes a predetermined operation, an operation record about the predetermined operation, the operation record at least comprising a target object, an operation time, and an action;
performing cluster analysis on the operation records to separately aggregate operation records of each target object;
receiving a request for displaying operation records, and acquiring a time period which is comprised in the request and during which operation records to be displayed are located; and
displaying, in a first display area according to the request, aggregated operation records of at least one target object during the time period.
